(19) United States
(12) Patent Application Publication
(10) Pub. No.: US 2007/0081789 A1
(43) Pub. Date: Apr. 12, 2007

(54) Time shifting for video

(75) Inventors: Jared D. Winick, Arlington, VA (US); Scott M. Kanowitz, Arlington, VA (US)

Correspondence Address: FOGG & POWERS LLC, 10 SOUTH FIFTH STREET, SUITE 1000, MINNEAPOLIS, MN, 55402, US

(73) Assignee: Lockheed Martin Corporation, Bethesda, MD (US)

(21) Appl. No.: 11/244,958

(22) Filed: Oct. 6, 2005

(51) Int. Cl. H04N 7/00

(52) U.S. Cl. 386/95

(57) ABSTRACT

A method of time shifting in a video recording is provided. The method includes dividing the video recording into one or more partitions, indexing each of the one or more partitions, and combining the one or more partitions to produce a second video recording that is used in retrieval of a particular video image at any time within the video recording.

### TECHNICAL FIELD

The present invention relates to image processing, and in particular, partitioning and displaying video images.

### BACKGROUND

Navigation within a video presentation provides an end user (viewer) the ability to review or edit important scenes or clips from either a live or pre-recorded video. These presentations are commonly in the form of an encoded streaming video feed from a monitoring vehicle or orbiting satellite, for example. Typically, the video is encoded with a type of compression scheme. These compression schemes are continually improving in terms of higher quality and smaller size, i.e. smaller bandwidth requirements.

The growing demand for streaming video, especially for live Internet feeds and television broadcasts, places pressure on current methods of video compression to provide live time shifting of video in which a viewer can seek out or skip to any point in a live video stream. Current encoding schemes (of higher quality and lower bandwidth) only support time shifting within a closed, pre-recorded video file. The closed file must already be indexed to allow for navigation within the file. Today, accomplishing any form of time shifting in a live recording session requires the use of lower quality, higher bandwidth compression schemes. Also, many compression schemes are limited to a certain number of index locations within the file. Allowing only certain points of entry restricts the viewer's search to a fixed number of locations.

If pre-recorded video files require modification in order to perform time shifting, additional burden is placed on the video delivery system. The file will be dismantled at one end and require reconstruction to meet the requirements of the viewer. For example, using non-standard video file formats make the time shifting operation less flexible, and may lead to a decrease in the types of streaming video products available for certain applications. Additional limitations may include a loss in location precision and an increase in the time required for searching.

For the reasons stated above and for other reasons stated below which will become apparent to those skilled in the art upon reading and understanding the specification, there is a need in the art for an improved method of partitioning and displaying video images.

### SUMMARY

Embodiments of the present invention provide methods for partitioning and displaying video images and will be understood by reading and studying the following specification.

In one embodiment, a method for time shifting in a video recording is provided. The method includes dividing the video recording into one or more partitions, indexing each of the one or more partitions, and combining the one or more partitions to produce a second video recording that is used in retrieval of a particular video image at any time within the video recording.

In one embodiment, a method for displaying video images is provided. The method includes transmitting the video images as an original video recording, partitioning the original video recording into one or more partitions, assembling the one or more partitions into a second video recording, receiving a request for a particular video image at a request time, wherein the request time is any time within the original video recording, determining which of the one or more partitions contains the particular video image, and acquiring the particular video image for further rendering by time shifting the second video recording to the request time.

In one embodiment, a framework for one or more video display applications is provided. The framework includes an application layer responsive to one or more function calls from the one or more video display applications and an indexing layer responsive to one or more function calls from one or both of the one or more video display applications and the application layer, the indexing layer adapted to provide time shifting capabilities to any particular time as requested by the one or more video display applications.

In one embodiment, a video display system is provided. The system includes a recording unit with at least one source of video images and at least one display unit, responsive to at least one broadcast of video images, the display unit adapted to partition the at least one broadcast of video images to provide time shifting capabilities within any portion of the at least one broadcast of video images.

### DRAWINGS

FIG. 1 is a block diagram of one embodiment of a video display system for partitioning and displaying video images in accordance with the present invention;

FIG. 2 is a block diagram of one embodiment of a framework for partitioning and displaying video images in accordance with the present invention;

FIG. 3 is a block diagram of one embodiment of an indexing layer used in partitioning video images in accordance with the present invention; and

FIG. 4 is a flow diagram illustrating one embodiment of a method of displaying video images in accordance with the present invention.

### DETAILED DESCRIPTION

In the following detailed description of the embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention address problems with partitioning and displaying video images and will be understood by reading and studying the following specification. Particularly, in one embodiment, a method for time shifting in a video recording is provided. The method includes dividing the video recording into one or more partitions, indexing each of the one or more partitions, and combining the one or more partitions to produce a second video recording that is used in retrieval of a particular video image at any time within the video recording.

Embodiments of the present invention may be implemented with present video image processing technology as well as current digital video reproduction technologies. This description is presented with enough detail to provide an understanding of the present invention, and should not be construed to encompass all necessary elements of video image processing.

Although the examples of embodiments in this specification are described in terms of streaming video, embodiments of the present invention are not limited to applications involving streaming video. Embodiments of the present invention are applicable to any video recording activity that requires the ability to time shift within any portion of the video recording to obtain a particular image contained in the recording. Alternate embodiments of the present invention to those described below allow for a variety of video formats to be used when choosing a video medium framework by separating the encoding and decoding requirements from the ability to search for a particular image within the media file provided.

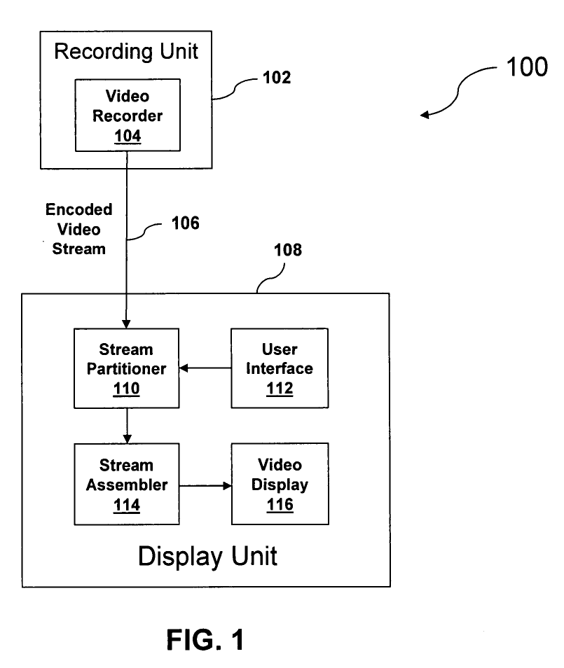

Referring to the drawings, FIG. 1 is a block diagram of one embodiment of a video display system, indicated generally at 100, for partitioning and displaying video images according to the teachings of the present invention. System 100 comprises recording unit 102, e.g., a monitoring vehicle, an unmanned aerial vehicle (UAV), or the like, communicatively coupled to display unit 108. It is noted that for simplicity in description, a single display unit 108 is shown in FIG. 1. However, it is understood that recording unit 102 supports any appropriate number of display units 108, e.g., one or more display units on a common data communications network. Recording unit 102 includes video recorder 104. In one embodiment, video recorder 104 provides a live digital video stream. Moreover, video recorder 104 is responsible for maintaining the recorded portion of the live digital video stream. In another embodiment, video recorder 104 provides a pre-recorded video file. Moreover, video recorder 104 is responsible for maintaining the pre-recorded video file. At least one display unit 108 is communicatively coupled to recording unit 102 by encoded video stream 106.

In one embodiment, encoded video stream 106 broadcasts encoded video images provided by video recorder 104 to display unit 108. In one embodiment, encoded video stream 106 broadcasts encoded video images in the WINDOWS MEDIA® video (WMV), Moving Picture Experts Group-4 (MPEG-4), H.264, or similar encoding formats provided by video recorder 104 to display unit 108. The broadcast provided by encoded video stream 106 is communicatively coupled to stream partitioner 110 of display unit 108. Display unit 108 also includes user interface 112 coupled with stream partitioner 110, stream assembler 114 coupled with stream partitioner 110, and video display 116 coupled with stream assembler 114.

In operation, video recorder 104 sends a live or pre-recorded video stream via encoded video stream 106 to be partitioned in stream partitioner 110 within display unit 108. Requests for specific images starting at any point in the live or pre-recorded video stream are issued by user interface 112 and transferred to stream partitioner 110. This request is in the form of a particular starting time when the specific images were recorded. Stream partitioner 110 determines which partition contains a first recorded frame corresponding to the particular starting time requested by user interface 112. The first recorded frame and subsequent frames are transferred to stream assembler 114 to be assembled as a pseudo-live stream. The pseudo-live stream is further rendered before being transferred to video display 116. The operations of display unit 108 remain independent of the operations of recording unit 102. In one embodiment, recording unit 102 is unaware that time shifting of the live or pre-recorded video stream is occurring. Recording unit 102 continues to record live images uninterrupted by any requests for time shifting. By combining the above operations in this manner, live time shifting can be accomplished for a plurality of highly-compressed video stream formats using the same video display system framework.

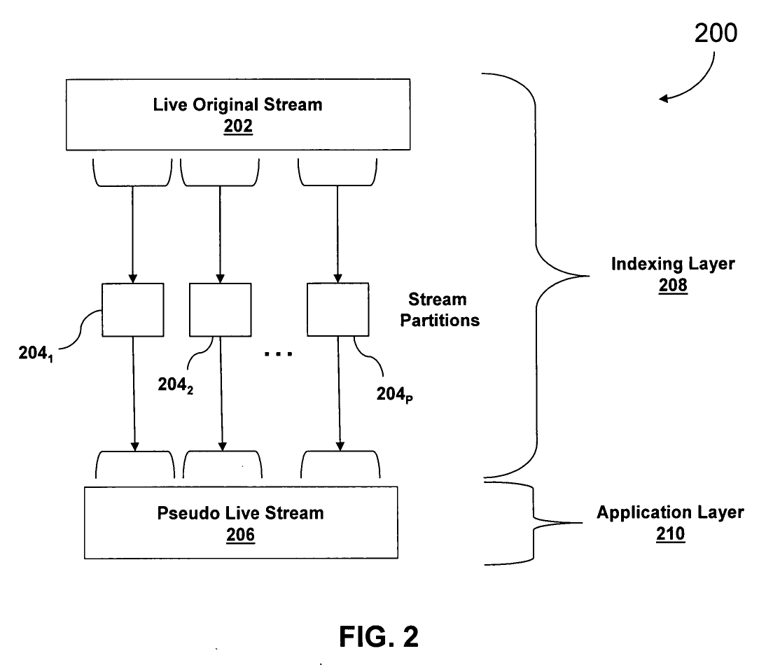

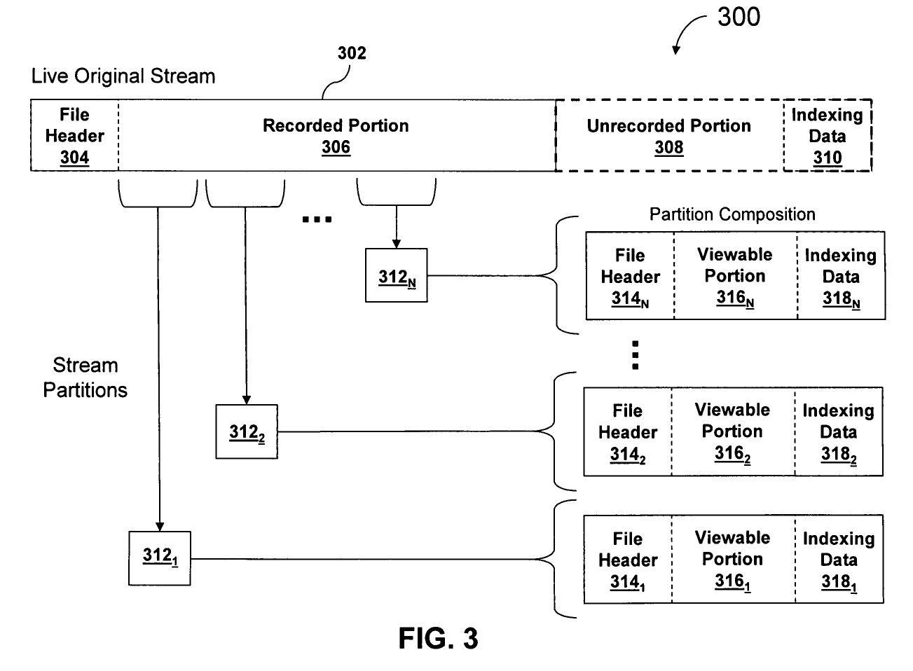

FIG. 2 is a block diagram of an embodiment of a framework, indicated generally at 200, for partitioning and displaying video images according to the teachings of the present invention. Framework 200 comprises indexing layer 208 containing live original stream 202 and stream partitions 204₁ to 204_{P}, and application layer 210 containing pseudo-live stream 206. In one embodiment, live original stream 202 is a live digital video stream. Live original stream 202 is partitioned into stream partitions 204₁ to 204_{P}. The method of partitioning live original stream 202 to create stream partitions 204₁ to 204_{P} is further described with respect to FIG. 3 below. In one embodiment, stream partitions 204₁ to 204_{P} are indexed in a sequential order within indexing layer 208. As requests for time shifting within live original stream are received by application layer 210, stream partitions 204₁ to 204_{P} are combined in pseudo-live stream 206 as described below. In one embodiment, pseudo-live stream 206 is presented within application layer 210 as a single file.

In operation, application layer 210 receives a request to time shift the display of live original stream 202 to begin at a particular time, e.g., two minutes from the start of a streaming video. In one embodiment, this request is received in an application programming interface (API) call from a software application that has access to application layer 210. Moreover, the software application is also responsible for the display of live original stream 202 in display unit 108 of FIG. 1. This request is passed down to indexing layer 208 which determines in which of stream partitions 204₁ to 204_{P} a starting frame corresponding to the particular time requested in live original stream 202 is located in. In one embodiment, indexing layer 208 calculates any required offset value within one of stream partitions 204₁ to 204_{P} in order to locate the starting frame. Once the starting frame is located, the starting frame and all sequential frames thereafter are passed from indexing layer 208 to application layer 210. In one embodiment, the starting frame and all sequential frames thereafter comprise pseudo-live stream 206. Moreover, pseudo-live stream 206 is processed for further rendering by the user software application that made the initial request. Framework 200 is implemented within a software application independent of any encoding format used by live original stream 202. By incorporating a separate mechanism for time shifting within a streaming video from a particular encoding format, the framework discussed here is suitable for video display system applications currently limited to encoding formats that have native support for time shifting. These encoding formats are typically low compression, i.e., low quality, formats.

FIG. 3 is a block diagram of an embodiment of an indexing layer, indicated generally at 300, used in partitioning video images according to the teachings of the present invention. Layer 300 comprises live original stream 302 and stream partitions 312₁ to 312_{N}. In one embodiment, live original stream 302 is a file containing streaming digital video images. Moreover, live original stream 302 is further subdivided into file header 304, recorded portion 306, unrecorded portion 308, and indexing data 310. In one embodiment, file header 304 includes any necessary identification of live original stream 304 such as file location, date, time, and the like. Further, recorded portion 306 contains streaming digital video images that have already been obtained, and unrecorded portion 308 is allocated to hold any future streaming digital video images as they are made available. Indexing data 310 is a portion of live original stream 302, e.g. memory located at the end of the file, allocated to contain identification, e.g. frame location data, of the images collected by recorded portion 306. In one embodiment, indexing data 310 is constantly updated as new images are recorded and stored in recorded portion 306.

As streaming digital video images are obtained and stored in recorded portion 306, the contents of recorded portion 306 are transferred and stored in stream partitions 312₁ to 312_{N}. Each of stream partitions 312₁ to 312_{N} are further subdivided into file headers 314₁ to 314_{N}, viewable portions 316₁ to 316_{N}, and indexing data 318₁ to 318_{N}. In one embodiment, each of file headers 314₁ to 314_{N} include any necessary identification of each of stream partitions 312₁ to 312_{N} such as file location, date, time, and the like. Further, each of viewable portions 316₁ to 316_{N} contain the particular section of streaming digital video images that have already been recorded and partitioned from live original stream 302. Each of indexing data 318₁ to 318_{N} contain identification, e.g. frame location data, of the images contained in each of stream partitions 312₁ to 312_{N}. In one embodiment, each of indexing data 318₁ to 318_{N} contains a complete record of all images that are stored in each of stream partitions 312₁ to 312_{N}. Since each index is complete in itself, this allows indexing layer 208 of FIG. 2 to fulfill any request from application layer 210 (of FIG. 2). Application layer 210 is capable of providing any image recorded at any time within any stream partition 312₁ to 312_{N}.

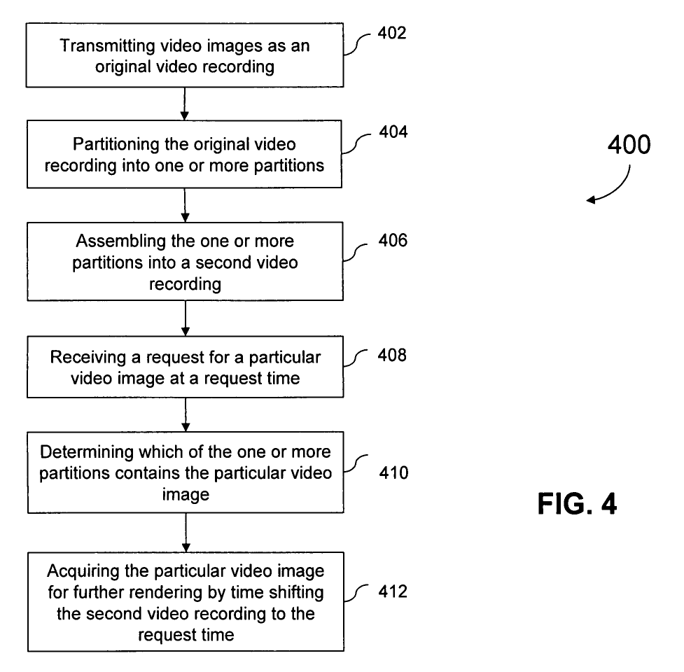

FIG. 4 is a flow diagram illustrating an embodiment of a method according to the teachings of the present invention in displaying video images. The method of FIG. 4 begins at block 402. Once the video images are partitioned, requests for time shifting within a video recording containing the video images can be fulfilled. The method of FIG. 4 is designed to time shift within any portion of the video recording to begin viewing a particular image contained in the recording or acquiring the particular image for further rendering.

At block 402, the method begins transmitting video images as an original video recording, and the method proceeds to block 404. In one embodiment, the original video recording is high compression, i.e., low bandwidth, encoded video. Moreover, the original video recording is either streaming video or pre-recorded video. At block 404, the method begins partitioning the original video recording into one or more partitions before proceeding to block 406. In one embodiment, the one or more partitions are individually indexed in sequential order. At block 406, the method begins assembling the one or more partitions into a second video recording before proceeding to block 408. In one embodiment, the second video recording is comprised of a single file. At block 408, the method begins receiving a request for a particular video image at a request time before proceeding to block 410. In one embodiment, the request time is any time within the original video recording. At block 410, the method begins determining which of the one or more partitions contains the particular video image before proceeding to block 412. In one embodiment, determining which of the one or more partitions contains the particular video image includes calculating any required offset in order to locate a starting frame of the particular video image. Once the starting frame is located, a location of the starting frame is passed onto the second recording. At block 412, the method begins acquiring the particular video image for further rendering by time shifting the second video recording to the request time. Once the image is acquired, the cycle is repeated upon request, beginning at block 402.

In view of the foregoing, it will be understood by those skilled in the art that the methods of the present invention can be implemented in combination with present video imaging technology. Variations and modifications may occur, which fall within the scope of the present invention, as set forth in the following claims.

What is claimed is:

1. A method for time shifting in a video recording, the method comprising:
dividing the video recording into one or more partitions;
indexing each of the one or more partitions; and
combining the one or more partitions to produce a second video recording that is used in retrieval of a particular video image at any time within the video recording.

2. The method of claim 1, wherein the video recording is encoded.

3. The method of claim 1, wherein the video recording comprises one of a streaming video and a pre-recorded video.

4. The method of claim 1, wherein the video recording contains a file header at the beginning of the recording.

5. The method of claim 1, wherein dividing the video recording into one or more partitions further comprises each of the one or more partitions containing a file header starting at a first frame of the one or more partitions.

6. The method of claim 1, wherein indexing each of the one or more partitions further comprises storing indexing data that ends at a final frame of the one or more partitions.

7. The method of claim 1, wherein combining the one or more partitions to produce a second video recording further comprises organizing the one or more partitions in sequential order.

8. The method of claim 1, wherein retrieval of the particular video image at any time within the video recording is separate from any continued recording in the video recording.

9. The method of claim 1, wherein retrieval of the particular video image at any time within the video recording is performed independently of any encoding format used for the video recording.

10. A method for displaying video images, the method comprising:
transmitting the video images as an original video recording;
partitioning the original video recording into one or more partitions;
assembling the one or more partitions into a second video recording;
receiving a request for a particular video image at a request time, wherein the request time is any time within the original video recording;
determining which of the one or more partitions contains the particular video image; and
acquiring the particular video image for further rendering by time shifting the second video recording to the request time.

11. The method of claim 10, wherein the original video recording is transmitted as an encoded video recording.

12. The method of claim 10, wherein the original video recording comprises one of a streaming video and a pre-recorded video.

13. The method of claim 10, wherein the one or more partitions are individually indexed in sequential order.

14. The method of claim 10, wherein assembling the one or more partitions into a second video recording further comprises assembling the one or more partitions into a single file.

15. The method of claim 10, wherein determining which of the one or more partitions contains the particular video image further comprises calculating any required offset in order to locate a starting frame of the particular video image.

16. The method of claim 10, wherein determining which of the one or more partitions contains the particular video image further comprises passing a location of the starting frame from a partition that contains the particular video image to the second recording.

17. A framework for one or more video display applications, the framework comprising:
an application layer responsive to one or more function calls from the one or more video display applications; and
an indexing layer responsive to one or more function calls from one or both of the one or more video display applications and the application layer, the indexing layer adapted to provide time shifting capabilities to any particular time as requested by the one or more video display applications.

18. The framework of claim 17, wherein the application layer is adapted to provide pseudo-live streams to the one or more video display applications.

19. The framework of claim 17, wherein the indexing layer is adapted to provide stream partitions and live original streams to the one or more video display applications, both the stream partitions and the live original streams containing a file header and indexing data.

20. A video display system, comprising:
a recording unit with at least one source of video images; and
at least one display unit, responsive to at least one broadcast of video images, the display unit adapted to partition the at least one broadcast of video images to provide time shifting capabilities within any portion of the at least one broadcast of video images.

21. The video display system of claim 20, wherein the at least one source of video images is compressed video images.

22. The video display system of claim 20, wherein the at least one source of video images comprise one of a streaming video source and a pre-recorded video source.

23. The video display system of claim 20, wherein the at least one broadcast of video images is a broadcast of encoded video images.

24. The video display system of claim 20, wherein time shifting capabilities within any portion of the at least one broadcast of video images is performed independently of any encoding format used for the at least one source of video images.

25. An apparatus for time shifting in a video recording, comprising:
means for dividing the video recording into one or more partitions;
means for indexing each of the one or more partitions; and
means for combining the one or more partitions to produce a second video recording that is used in retrieval of a particular video image at any time within the video recording.

26. The apparatus of claim 25, wherein the video recording is encoded.

27. The apparatus of claim 25, wherein the video recording comprises one of a streaming video and a pre-recorded video.

28. The apparatus of claim 25, wherein the video recording contains a file header at the beginning of the recording.

29. The apparatus of claim 25, wherein the means for dividing the video recording into one or more partitions further comprises each of the one or more partitions containing a file header starting at a first frame of the one or more partitions.

30. The apparatus of claim 25, wherein the means for indexing each of the one or more partitions further comprises storing indexing data that ends at a final frame of the one or more partitions.

31. The apparatus of claim 25, wherein the means for combining the one or more partitions to produce a second video recording further comprises organizing the one or more partitions in sequential order.

32. The apparatus of claim 25, wherein retrieval of the particular video image at any time within the video recording is separate from any continued recording in the video recording.

33. The apparatus of claim 25, wherein retrieval of the particular video image at any time within the video recording is performed independently of any encoding format used for the video recording.

34. An apparatus for displaying video images, comprising:
means for transmitting the video images as an original video recording;
means for partitioning the original video recording into one or more partitions;
means for assembling the one or more partitions into a second video recording;
means for receiving a request for a particular video image at a request time, wherein the request time is any time within the original video recording means for determining which of the one or more partitions contains the particular video image; and
means for acquiring the particular video image for further rendering by time shifting the second video recording to the request time.

35. The apparatus of claim 34, wherein the original video recording is transmitted as an encoded video recording.

36. The apparatus of claim 34, wherein the original video recording comprises one of a streaming video and a pre-recorded video.

37. The apparatus of claim 34, wherein the one or more partitions are individually indexed in sequential order.

38. The apparatus of claim 34, wherein the means for assembling the one or more partitions into a second video recording further comprises means for assembling the one or more partitions into a single file.

39. The apparatus of claim 34, wherein the means for determining which of the one or more partitions contains the particular video image further comprises means for calculating any required offset in order to locate a starting frame of the particular video image.

40. The apparatus of claim 34, wherein the means for determining which of the one or more partitions contains the particular video image further comprises means for passing a location of the starting frame from a partition that contains the particular video image to the second recording.
